(19) United States
(12) Patent Application Publication
(10) Pub. No.: US 2005/0229491 A1
(43) Pub. Date: Oct. 20, 2005

(54) Systems and methods for generating hydrogen from hycrocarbon fuels

(75) Inventor: Daniel G. Loffler, Bend, OR (US)

Correspondence Address: DARBY & DARBY P.C., P. O. BOX 5257, NEW YORK, NY, 10150-5257, US

(73) Assignee: Nu Element, Inc., Tacoma, WA (US)

(21) Appl. No.: 11/050,371

(22) Filed: Feb. 2, 2005

Related U.S. Application Data
(60) Provisional application No. 60/541,128, filed on Feb. 3, 2004.

(51) Int. Cl. B01J 8/00

(52) U.S. Cl. 48/198.7; 48/127.9

(57) ABSTRACT

The present invention provides a system and a method to reform hydrocarbon fuels, including sulfur-laden liquid fuels, to produce a reformate stream containing hydrogen. The system comprises a reforming reactor using a hydrocarbon stream and a water stream as reactants. The water stream is mixed with a hydrogen-rich stream prior to mixing with the hydrocarbon stream and fed to the reforming reactor, which contains a precious metal based catalyst. In one embodiment of the present invention, the temperature of the catalyst is lower at the inlet to prevent formation of coke by pre-reforming heavy hydrocarbons to methane, and higher at the outlet for efficient production of hydrogen. In another embodiment, air is introduced periodically into the system to burn off any metal sulfides and coke deposits that could form. In another embodiment, pure hydrogen is separated from the reformate stream using a hydrogen selective, sulfur-tolerant membrane or by pressure swing adsorption. Thus, the system and method of the present invention can be used to process sulfur-laden, heavy hydrocarbons to produce PEM fuel-cell quality hydrogen.

### CROSS-REFERENCE TO RELATED APPLICATIONS

This application claims priority under 35 U.S.C. §119(e) to U.S. Provisional Patent Application No. 60/541,128 , filed Feb. 3, 2004, which application is hereby incorporated by reference.

### FIELD

The present invention relates to systems and methods for producing hydrogen from a hydrocarbon fuel.

### BACKGROUND

The main issue that has prevented the use of sulfur-laden hydrocarbon fuels in fuel processors for hydrogen generation has been catalyst deactivation by coke deposition and by metal sulfide formation.

Coke forms readily when heavy hydrocarbon fuels are heated to the high reforming temperatures required for efficient hydrogen production. The catalyst then becomes ineffective by coke accumulation. In U.S. Pat. No. 3,441,395, Dent et al., incorporated by reference, taught the use of a two-stage reformer, with a first stage operating at lower temperatures than the second stage, to avoid coke formation when reforming liquid hydrocarbons. Mason et al., ACS Fuel Cell Chemistry Division Preprints, 2002, 47, 558-559, incorporated by reference, used a two-stage reformer to prevent coke formation when using propane as the hydrocarbon feed. Loffler et al., Journal of Power Sources, Vol. 117, issues 1-2, pages 84-91 (2003), incorporated by reference, teach using reformed natural gas and propane in a single reactor with an axial temperature gradient. In said reformer, the feed is partially converted (pre-reformed) at low temperatures (approximately 500° C.) to eliminate coke formation, while the final conversion takes place at approximately 800° C. to maximize hydrogen production.

In the above described strategy for mitigating coke formation, which is to pre-reform at low temperatures, the formation of metal sulfides is facilitated. At pre-reforming temperatures, sulfur in the hydrocarbon fuels reacts readily with the fuel processing catalysts and forms catalytically inactive metal sulfides. Those metal sulfides are less stable at the high reforming temperatures. In U.S. Pat. No. 4,755,498, Setzer et al., incorporated by reference, teach using noble metal catalysts at temperatures in excess of 700° C. to reform a methane stream containing sulfur. This method cannot be used to reform heavier hydrocarbon fuels, or even natural gas, when the fuel stream contains some level of hydrocarbons heavier than methane, because those fuels react to form coke at the temperatures required for the noble metal catalysts to become sulfur-tolerant.

Although the sulfur content in transportation fuels is approximately 500 ppm and logistic fuels could contain up to 1% sulfur, fuel processor catalysts typically cannot tolerate fuel compositions with sulfur levels higher than ˜1 ppm. Thus, even the sulfur levels mandated by EPA specifications for transportation fuels for 2006, 15 ppm, are detrimental for fuel processors. The conventional technology used in oil refineries to remove sulfur from hydrocarbon fuels is hydrodesulfurization, a process that involves catalytic treatment with hydrogen at pressures higher than 150 psi to convert the various sulfur compounds present in the fuel to hydrogen sulfide. The hydrogen sulfide is then separated and converted to elemental sulfur by the Claus process. This technology, however, is impractical to use in fuel processors for fuel cell applications mainly because of the cost of compressing hydrogen.

Sulfur management in the fuel processor environment generally includes capturing the sulfur species in an adsorbent bed at the front end of the processor. Adsorption beds used to desulfurize hydrocarbon feeds are effective in removing only light sulfur species in the gas phase. Liquid feeds can be desulfurized by making the sulfur in the fuel react over a reforming catalyst under pre-reforming conditions and replacing this catalyst once it becomes inactive. This approach complicates the system design because the pre-reformer has to be physically separated from the reformer for ease of removal during periodic servicing. Also, the amount of sulfur that can be removed per unit mass of adsorbent is limited; for this reason, the mass of adsorbent needed to treat sulfur-laden fuels becomes impractically large.

Accordingly, there is a need in the art for an improved method for processing sulfur-laden hydrocarbon fuels while preventing the formation of both coke and metal sulfides. The present invention addresses and resolves this problem.

### BRIEF SUMMARY

One embodiment is a system for producing a hydrogen-rich stream. The system includes a fuel processing reactor comprising a reaction zone and a reforming catalyst disposed in the reaction zone for converting a feed stream to a reformate stream comprising hydrogen; and a mixing system to admix a water stream, a hydrogen-rich stream, and a hydrocarbon stream forming the feed stream that is fed to the reaction zone. The hydrogen-rich stream optionally can be a portion of the reformate stream.

Another embodiment is a system for producing hydrogen. The system includes a fuel processing reactor comprising a reaction zone and a reforming catalyst disposed in the reaction zone to convert a feed stream to a reformate stream comprising hydrogen; a hydrogen separation device to separate a hydrogen stream from a retentate stream; and a burner that receives at least a portion of the retentate stream and, using the retentate stream as fuel, supplies heat to at least a portion of the fuel processing reactor. The feed stream comprises a combination of a water stream, a hydrogen-rich stream, and a hydrocarbon stream.

Yet another embodiment is a method for producing a hydrogen-rich stream. The method includes mixing a water stream, a hydrogen-rich stream, and a hydrocarbon stream forming a feed stream. The feed stream is injected into a reactor having an inlet and an outlet and a reforming reaction zone containing a reforming catalyst material. The feed stream is reacted in the reforming reaction zone to produce a gaseous reformate stream richer in hydrogen than said feed stream.

### BRIEF DESCRIPTION OF THE DRAWINGS

Non-limiting and non-exhaustive embodiments of the present invention are described with reference to the following drawing. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a schematic block diagram illustrating one embodiment of the present method and apparatus.

### DETAILED DESCRIPTION

The following detailed description illustrates the invention by way of example, and it is not in any way intended to limit the principles of the invention. This description will clearly enable one skilled in the art to make and use the invention, and it describes several embodiments, adaptations, variations, alternatives and uses of the invention, including what is currently considered to be the best mode of practicing the invention.

The present invention relates to systems and methods for producing hydrogen from a hydrocarbon fuel, which can be a sulfur-laden hydrocarbon fuel, and are particularly useful for supplying hydrogen to PEM fuel cells.

The present invention is also directed towards processing hydrocarbon fuel streams, which may be sulfur-laden, to produce hydrogen without requiring the removal of sulfur in the fuel prior to processing. The hydrocarbon fuel stream may comprise a fuel selected from the group consisting of military logistic fuels, gasoline, diesel, natural gas, ethane, butane, light distillates, dimethyl ether, methanol, ethanol, propane, naphtha, kerosene, and combinations thereof.

The inventive systems and methods disclosed herein prevent or reduce the formation of coke by using a reformer with an axial temperature gradient such that the heavy hydrocarbons are partially converted at low temperatures, while full conversion takes place at higher temperatures. The formation of metal sulfides is suppressed by providing an atmosphere rich in hydrogen at all points in the reformer, and formulating the reforming catalyst using precious metals with low affinity for sulfur such as platinum and iridium in excess hydrogen. As a backup feature, this inventive method optionally includes a periodic burn-off of the catalyst to eliminate any small amounts of coke and sulfides that could form. The frequency at which this procedure occurs can vary from hours to days or weeks; and can depend on a variety of factors including, for example, the type of fuel used, the type of catalyst used, the temperature of the reaction zones, and the composition of the stream entering the reaction zones.

The inventive fuel processing system comprises a fuel processing reactor containing a reaction zone with a reforming catalyst for converting a feed stream to a reformate stream, wherein the reaction zone has a temperature profile, with temperatures increasing from inlet to outlet, and the reforming catalyst comprises precious metals. A mixing device is provided to mix a water stream, a hydrogen-rich stream, and a hydrocarbon stream forming a mixed stream that is fed to the reaction zone. An air inlet is provided upstream of said mixing device. The heat of reaction is provided by, for example, either an open flame burner or by catalytic combustion. The reformer catalyst and the combustion catalyst can be, for example, packed granular materials or deposited on ceramic or metal structures.

In an embodiment of the present fuel processing system a portion of said reformate stream is introduced into a water vapor stream forming a mixed stream comprising hydrogen. A hydrocarbon fuel stream is introduced into said admixed stream prior to contacting the reforming catalyst. The reformate stream may be introduced into said water vapor stream via, for example, a compressor or an ejector. The hydrocarbon fuel may be introduced into said admixed stream via, for example, an injector fluidly connected to said ejector. The shut down procedure may comprise a step of flowing air through the system to burn off carbon and sulfide deposits.

In another embodiment of the present fuel processing system the reaction zone comprises two separate reactors, the first reactor operating at lower temperatures, and the second reactor operating at higher temperatures.

Although these embodiments of the apparatus and methods are described herein as comprising one or two fuel processing reactors, and one or two mixing systems, additional reactors and mixers may be included.

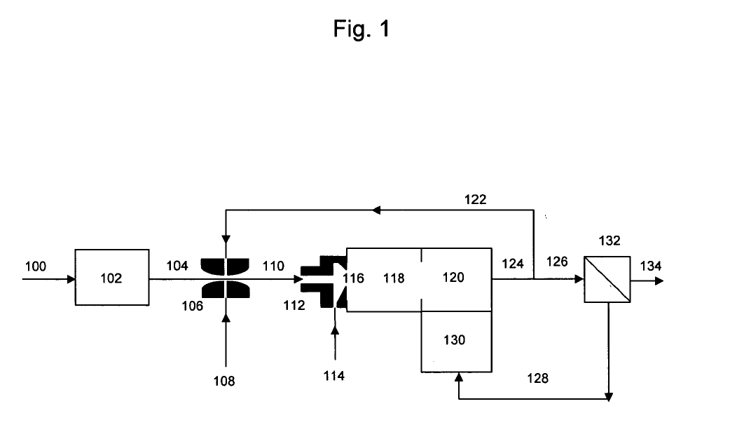

One embodiment of the system for producing hydrogen from a hydrocarbon fuel is illustrated schematically in FIG. 1. A pressurized water stream 100 is vaporized in vaporizer 102; the water vapor stream 104 flows as the motive fluid in ejector 106 suctioning the reformate recycle stream 122 and, optionally, air stream 108. The ejector discharge 110 is the pattern fluid for injector 112. A pressurized hydrocarbon fuel stream 114 is pulverized in injector 112 and combined with the ejector discharge 110 (for example, the combined water vapor stream 104 and reformate recycle stream 122). It will be recognized that other methods and devices for combining the water vapor stream, hydrogen-rich stream (e.g., the reformate recycle stream), and hydrocarbon fuel stream can be used.

The hydrocarbon fuel in injector discharge stream 116 enters the reactor and is typically vaporized prior to, or upon, contacting a reforming catalyst disposed in the low-temperature reaction zone 118 of the reactor. The reforming catalyst is typically a metal or alloy which preferably resist the formation of metal sulfides at the reaction temperatures. Examples of suitable catalysts include precious metal, or alloys thereof, such as, for example, platinum, iridium, rhodium, palladium, ruthenium, platinum/iridium, and nickel In at least one embodiment, the low-temperature reaction zone is at a temperature in the range of 200 to 600° C. and often in the range of 400 to 500° C. Suitable temperatures for the low-temperature reaction zone and high-temperature reaction zone will depend on a variety of factors including, for example, the type of catalyst used, the ratio of components in stream 116, the type of fuel used, the amount of sulfur in the fuel, and the application for which hydrogen is being produced.

The partially reformed stream then contacts the catalyst in the high-temperature reaction zone 120. In at least one embodiment, the high-temperature reaction zone is at a temperature in the range of 600 to 900° C. and often in the range of 700 to 850° C. It will be understood that the low-temperature zone and high-temperature zone can be physically separated or that these zones represent regions along a continuum of temperature change within the reactor.

Part of the reformate stream 124 is suctioned by ejector 106 and recycled as stream 122; the remaining reformate stream 126 is fed to a hydrogen separation device 132 where it is separated into a hydrogen stream 134 that preferably comprises substantially pure hydrogen and a retentate stream 128. The retentate stream 128 is optionally used to fuel a burner 130 to provide heat for the reforming process in the high-temperature zone 120. The flue gases from burner 130 may be diverted to provide process heat to one or more sub-systems including (but not limited to) vaporizer 102, reaction zone 118, and separation device 132. Hydrogen stream 134 may be supplied, for example, to a fuel cell stack for generating electricity.

In at least some embodiments, the ratio of water in stream 104 to carbon in stream 114 is in the range of 2 moles water/atom of carbon to 6 moles of water/atom of carbon, where the number of atoms of carbon refers to the average number of carbon atoms per molecule of hydrocarbon fuel. For example, butane has 4 carbon atoms, ethane has two carbon atoms, and a mixture of 50 mol % butane and 50 mol % ethane has an average of 3 carbon atoms per molecule of hydrocarbon fuel. Sufficient reformate stream 126 is preferably provided to the ejector 106 to produce a ratio of at least 7 moles hydrogen/atom of sulfur in the hydrocarbon fuel stream, where the number of atoms of sulfur refers to the average number of sulfur atoms per molecule of hydrocarbon fuel. The amount of hydrogen per sulfur atom can depend on a number of factors including, for example, the type of hydrocarbon fuel used, the temperatures in the reactor, and the type of catalyst used. In some embodiments, the ratio of hydrogen to sulfur is at least 20 moles hydrogen/atom of sulfur, at least 100 moles hydrogen/atom of sulfur, at least 300 moles hydrogen/atom of sulfur, or at least 1000 moles hydrogen/atom of sulfur.

As used in this description and in the appended claims, hydrocarbon fuel means gaseous or liquid fuels comprising aliphatic hydrocarbons and oxygenated derivatives thereof, and may further comprise aromatic hydrocarbons and oxygenated derivatives thereof. Reformate stream means the gas stream comprising hydrogen produced from a hydrocarbon fuel by a fuel processing reactor, including, but not limited to, steam reformers, partial oxidation reformers, catalytic partial oxidation reformers, autothermal reformers, plasma reformers, and shift reactors. As used herein, when two components are fluidly connected to one another, there may be other components in between them, and the other components may affect the fluid connection but not eliminate it altogether.

In conventional plug flow steam reformers the concentration of hydrogen is low at the inlet and it increases downstream into the reactor. Catalyst deactivation by sulfur poisoning occurs first at the reformer inlet because there is little or no hydrogen available there to prevent sulfide formation. As this catalyst deactivates, the zone of low hydrogen concentration moves downstream into the reactor and the catalyst is progressively deactivated along the axial reactor direction. A front of deactivated catalyst progresses to the reactor outlet, eventually shutting down the reactor completely.

This inventive method and system provide high hydrogen/sulfur and hydrogen/carbon molar ratios at all points in the reformer. A preferred method is to recycle a portion of the reformer effluent back to the reformer inlet. FIG. 1 shows a flow diagram for a preferred embodiment of the inventive fuel processor. A water stream 100 is pumped to a vaporizer 102 to generate steam. Water vapor stream 104 flows through a venturi ejector 106 creating a vacuum that suctions a portion 122 of the reformate stream. The ejector discharge stream 110 is fed to an injector 112 where preheated liquid hydrocarbon fuel is pulverized into small droplets that vaporize in the hydrogen/steam-rich environment of stream 116 and rapidly come in contact with the pre- reforming catalyst in low-temperature zone 118. The reformer effluent, or reformate stream 124 splits into a recycle stream 122 and stream 126. A high-purity hydrogen stream 134 is separated from stream 126 using a hydrogen-selective membrane 132 or other hydrogen separation component; the residual gas, or retentate stream 128, is combusted in the burner 130 to provide the heat of reaction. The hot flue gases provide heat to the pre-reformer and then to the water vaporizer before being discharged into the atmosphere. The flue gases typically contain most or all of the sulfur in the feed.

Suitable hydrogen-selective membranes for separation of the hydrogen stream 132 include the H₂ Separation Membrane from UBE Industries Ltd. Typically, when using such membranes, the system is kept at relatively high pressure during operation. For example, the pressure may range from 2 to 100 atmospheres. It will be recognized that methods or components other than a hydrogen-selective membrane can be used to separate the hydrogen stream 132 from the retentate stream 128. One example of such methods includes pressure-swing adsorption (PSA) using an adsorbing material, such as zeolites, activated carbon, or similar high-surface area materials to adsorb the impurities in stream 126 (for example, hydrogen sulfide, carbon monoxide, and carbon dioxide) at high pressure and then later lowering the pressure to allow desorption of those impurities and regeneration of the adsorbing material.

The system can be started up by fueling burner 130 using a slipstream (not shown) from fuel stream 114. Once the system reaches the operating temperature, a water stream 100 is fed to vaporizer 102, and fuel stream 114 is fed to injector 112. At this time there is no hydrogen in stream 122, consequently, some metal sulfides may form at the inlet of catalyst zone 118. Those sulfides decompose soon after hydrogen starts being recycled in stream 122. When the system is shut down, the flow of stream 114 is stopped first. Optionally, air stream 108 can be turned on to burn any coke and metal sulfides that could have accumulated in the injector and reaction zone.

In another embodiment of the present inventive process, stream 124 passes over a sulfur adsorbent, preferably ZnO, to remove substantially all sulfur from the recycle steam 122 and retentate stream 128. The flue gases in this embodiment are substantially free of sulfur.

In another embodiment, high-purity hydrogen stream 134 is fed to a fuel cell stack to generate electrical power.

### EXAMPLES

### Example I

The system of FIG. 1 is operated with a logistic diesel fuel as feed. The molecular weight of the fuel is 220 gm/mole, the molecules contain on average 16 carbon atoms each, and their hydrogen to carbon ratio is 1.8. The sulfur content of the fuel is one percent by weight. The flow rate of stream 100 is adjusted relative to stream 114 so that the number of moles of water in stream 104 is three times the number of atoms of carbon in stream 114. The fuel is completely converted to hydrogen and carbon oxides in reaction zones 118 and 120. The flow rate of stream 122 is adjusted to be equal to the flow rate of stream 126. Stream 116 contains then 340 moles of hydrogen per atom of sulfur, and 4 moles of water per atom of carbon.

The temperature of reaction zone 118 is set to 500° C. The active metal in the catalyst is iridium. According to the teachings of U.S. Pat. No. 3,441,395 of Dent et al., no coke is formed when the number of moles of water per carbon atom fed to the catalyst is at least 2.5. Predominance diagrams were calculated using the software HSC Chemistry Ver. 4.1, Outokumpu Research Oy, Pori, Finland. Said diagrams show that for an Ir catalyst the metallic form predominates over the metal sulfide when the catalyst operates at 500° C. in an atmosphere containing more than 10 moles of hydrogen per atom of sulfur. Because stream 116 contains 4 moles of water per atom of carbon and 340 moles of hydrogen per atom of sulfur, no coke or metal sulfides are formed on the catalyst during steady state operation. Small amounts of coke and metal sulfides that may form during start up or other transient operation are removed by introducing air stream 108 at shut down, after stopping the fuel stream 114.

### Example II

The system of FIG. 1 is operated with a low-sulfur diesel fuel as feed. The molecular weight of the fuel is 220 gm/mole, the molecules contain on average 16 carbon atoms each, and their hydrogen to carbon ratio is 1.8. The sulfur content of the fuel is fifteen parts per million by weight. The flow rate of stream 100 is adjusted relative to stream 114 so that the number of moles of water in stream 104 is three times the number of atoms of carbon in stream 114. The fuel is completely converted to hydrogen and carbon oxides in reaction zones 118 and 120. The flow rate of stream 122 is adjusted to be equal to one percent the flow rate of stream 126. Stream 116 contains then 4400 moles of hydrogen per atom of sulfur, and 3 moles of water per atom of carbon. The temperature of reaction zone 118 is set to 500° C. The active metal in the catalyst is rhodium. Predominance diagrams indicate that for a Rh catalyst the metallic form predominate over the metal sulfide when the catalyst operates at 500° C. in an atmosphere containing more than 300 moles of hydrogen per atom of sulfur. Because Stream 116 contains 3 moles of water per atom of carbon and 4400 moles of hydrogen per atom of sulfur, no coke or metal sulfides are formed on the catalyst during steady state operation. Small amounts of coke and metal sulfides that may form during start up or other transient operation are removed by introducing air stream 108 at shut down, after stopping the fuel stream 114.

While preferred embodiments of the present invention have been described, it will be apparent to those skilled in the art that many changes and modifications may be made without departing from the invention in its broader aspects. The appended claims are therefore intended to cover all such changes and modifications as fall within the true spirit and scope of the invention.

1. A system for producing a hydrogen-rich stream, the system comprising:
a fuel processing reactor comprising a reaction zone and a reforming catalyst disposed in the reaction zone for converting a feed stream to a reformate stream comprising hydrogen;
a mixing system to admix a water stream, a hydrogen-rich stream, and a hydrocarbon stream forming the feed stream that is fed to the reaction zone.

2. The system of claim 1, wherein the reaction zone has a temperature profile, with temperatures increasing from inlet to outlet.

3. The system of claim 1, wherein the mixing system is configured and arranged so that the hydrogen-rich stream comprises a portion of the reformate stream.

4. The system of claim 1, wherein the reforming catalyst comprises a precious metal

5. The system of claim 1, further comprising an air inlet located at or upstream of said mixing system

6. The system of claim 5, wherein the reforming catalyst comprises platinum, iridium, platinum/iridium, or rhodium.

7. The system of claim 1, wherein the reaction zone comprises two separate reaction subzones, a first reaction subzone operating at temperatures between 200 and 600 C, and a second reaction subzone operating at temperatures between 600 and 900 degree C.

8. The system of claim 1, further comprising a sulfur adsorbent material downstream of the reaction zone.

9. A system for producing hydrogen, the system comprising:
a fuel processing reactor comprising a reaction zone and a reforming catalyst disposed in the reaction zone to convert a feed stream to a reformate stream comprising hydrogen, wherein the feed stream comprises a combination of a water stream, a hydrogen-rich stream, and a hydrocarbon stream;
a hydrogen separation device to separate a hydrogen stream from a retentate stream; and
a burner that receives at least a portion of the retentate stream and, using the retentate stream as fuel, supplies heat to at least a portion of the fuel processing reactor.

10. The system claim 9, further comprising a mixing system to form the feed stream as an admixture of the water stream, the hydrocarbon stream, and the hydrogen-rich stream.

11. The system of claim 10, wherein the mixing system is configured and arranged to provide a portion of the reformnate stream as the hydrogen-rich stream.

12. A method for producing a hydrogen-rich stream comprising:
(a) mixing a water stream, a hydrogen-rich stream, and a hydrocarbon stream forming a feed stream;
(b) injecting the feed stream into a reactor having an inlet and an outlet and a reforming reaction zone containing a reforming catalyst material; and
(c) reacting the feed stream in the reforming reaction zone to produce a gaseous reformate stream richer in hydrogen than said feed stream.

13. The method of claim 12, wherein reacting the feed stream in the reforming reaction zone comprises i) reacting the feed stream in a first reaction subzone at a first temperature and then ii) reacting the feed stream in a second reaction subzone at a second temperature, wherein the second temperature is greater than the first temperature.

14. The method of claim 12, further comprising diverting a portion of the reformate stream to form the hydrogen-rich stream.

15. The method of claim 12, further comprising separating the hydrogen out of the reformate stream to form a hydrogen stream and leave a retentate stream.

16. The method of claim 15, further comprising diverting at least a portion of the retentate stream to a burner for use as fuel.

17. The method of claim 16, further comprising operating the burner to heat at least a portion of the reforming reaction zone.

18. The method of claim 17, further comprising using flue gases generated by the burner to heat another portion of the reactor.

19. The method of claim 12, further comprising halting the injection of the feed steam into the reactor and injecting air into the reactor to reduce contaminant concentration in the reactor.

20. The method of claim 12, wherein mixing a water stream, a hydrogen-rich stream, and a hydrocarbon stream comprises i) mixing the water stream and the hydrogen-rich stream and then ii) adding the hydrocarbon stream.
